(19) United States
(12) Patent Application Publication
(10) Pub. No.: US 2009/0041007 A1
(43) Pub. Date: Feb. 12, 2009

(54) METHOD AND SYSTEM FOR OBTAINING INTERNET RADIO RESOURCES BASED ON SESSION INITIATION PROTOCOL

(75) Inventor: Jian-Jun Qian, Taipei Hsien (TW)

Correspondence Address: LADAS & PARRY, 5670 WILSHIRE BOULEVARD, SUITE 2100, LOS ANGELES, CA, 90036-5679, US

(73) Assignee: WISTRON CORPORATION, Taipei Hsien (TW)

(21) Appl. No.: 11/935,109

(22) Filed: Nov. 5, 2007

(30) Foreign Application Priority Data
Aug. 8, 2007 (CN) 200710141113.3

(51) Int. Cl. H04L 12/52

(52) U.S. Cl. 370/352

(57) ABSTRACT

A method for obtaining Internet radio resources based on Session Initiation Protocol (SIP) is adapted for use between an administrator server and at least one client terminal. The method includes the following steps: (a) enabling the client terminal and the administrator server to set up a tunnel based on the SIP; (b) enabling the client terminal to send a SIP message requesting radio station data to the administrator server through the tunnel; and (c) enabling the administrator server to provide the radio station data to the client terminal through the tunnel. Since SIP has very good flexibility and functionality, obtaining Internet radio resources based on the SIP can overcome inconveniences associated with searching by the user.

### CROSS-REFERENCE TO RELATED APPLICATION

This application claims priority of Chinese Application No. 200710141113.3, filed on Aug. 8, 2007.

### BACKGROUND OF THE INVENTION

1. Field of the Invention

The invention relates to a radio resources sharing method and system, more particularly to a method and system for obtaining Internet radio resources based on Session Initiation Protocol.

2. Description of the Related Art

Using radio or stereo equipment to listen to broadcast radio is a form of entertainment that many people cannot do without. For the selection of radio channels, some radios or stereo equipment permit the user to slowly tune to and store his/her favorite radio channels in a manual manner, while some can scan different radio channel frequencies and store them automatically, so that the user does not have to memorize the radio channel frequencies every time he/she wants to listen to them in the future.

In addition to physical radios and stereo equipment, with the development of the Internet, Internet radio has become a trend for radio broadcast. For example, Windows Media Player and RealOne Player are computer playback software that can be used to listen to Internet radio broadcast. Since the communication addresses of Internet broadcasting radio stations are distributed all over the world, if a listener only knows the name of an Internet radio station but does not have the website thereof, the listener needs to search for the web address of the Internet radio station with keywords, and add the same to his/her favorite radio playlist. As obtaining Internet radio resources is fairly troublesome, users may get frustrated and may not want to listen to Internet radio.

On the other hand, the current Session Initiation Protocol is used to set up, change and terminate one or more sessions among users, and primarily follows back-to-back oriented method of communication over the Internet, e.g., between a client terminal and a server terminal. The process of communication is composed of a series of messages between the terminals. The content of a message generally includes a first line, a message header, and a message body. The first line is used to label the form of the message. Types of message forms include requests and responses. Types of request messages include INVITE, REGISTER, ACK, BYE, etc. One type of a response message is a 200 OK message. The message header includes fields for recording the path along which the request message is sent for subsequent transmission of a response message along the same path, and for recording session identification codes, etc. The message body records different contents of description according to different messages, e.g., recording a description of media message forms acceptable to a sending end.

Furthermore, the Session Initiation Protocol includes a so-called event notification mechanism, whereby a subscribe message can be sent to the server terminal to conduct a dialogue when the client terminal is interested in a specific event. During a dialogue session, the server terminal will send a notify message to the client terminal upon any change in the event, and the dialogue is terminated when either party issues a BYE message.

### SUMMARY OF THE INVENTION

In view of the fact that existing Internet radios still require users to manually input and record communication addresses employing the HTTP Communication Protocol, which is quite time-consuming and inconvenient, and since Session Initiation Protocol provides excellent flexibility and functionality in message transmission, the obtainment of Internet radio resources based on Session Initiation Protocol will be a feasible alternative.

A primary object of the present invention is to provide a method and system for obtaining Internet radio resources based on Session Initiation Protocol.

The method for obtaining Internet radio resources based on Session Initiation Protocol according to the invention is adapted for use between an administrator server and at least one client terminal. The method includes the following steps: (a) enabling the client terminal and the administrator server to set up a tunnel based on the Session Initiation Protocol (SIP); (b) enabling the client terminal to send a SIP message requesting radio station data to the administrator server through the tunnel; and (c) enabling the administrator server to provide requested radio station data to the client terminal through the tunnel.

Another object of the present invention is to enable a radio station terminal to provide radio station data to an administrator server by means of the Session Initiation Protocol.

Accordingly, the method for obtaining Internet radio resources based on Session Initiation Protocol of this invention is adapted for use between an administrator server and at least one radio station terminal. The method comprises the following steps: (a) enabling the radio station terminal and the administrator server to set up a tunnel based on the Session Initiation Protocol (SIP); (b) enabling the radio station terminal to send a SIP message appended with radio station data to the administrator server through the tunnel; and (c) enabling the administrator server to obtain the SIP message through the tunnel and to store the radio station data therein in a radio resource database.

A further object of the present invention is to enable a client terminal to search an administrator server for radio station data by means of the Session Initiation Protocol.

Accordingly, the method for obtaining Internet radio resources based on Session Initiation Protocol of the present invention is adapted for use between an administrator server having a radio resource database and a client terminal. The method comprises the following steps: (a) enabling the client terminal and the administrator server to set up a tunnel based on the Session Initiation Protocol (SIP); (b) enabling the client terminal to send a SIP message to the administrator server through the tunnel, the SIP message being appended with a search command to search for a radio station terminal; and (c) enabling the administrator server to obtain the SIP message through the tunnel, to locate matching radio station data from the radio resource database based on the search command in the SIP message, and to send another SIP message having the matching radio station data to the client terminal.

Still another object of the present invention is to enable a client terminal to request trial listening radio media data from an administrator server by means of the Session Initiation Protocol.

The method for obtaining Internet radio resources based on Session Initiation Protocol according to the present invention is adapted for use between an administrator server having a radio resource database, and a client terminal. The method comprises the following steps: (a) enabling the client terminal and the administrator server to set up a tunnel based on the Session Initiation Protocol (SIP); (b) enabling the client terminal to send a SIP message appended with a trial listening request to the administrator server through the tunnel; and (c) enabling the administrator server to obtain the SIP message through the tunnel, to locate matching media data from the radio resource database based on the trial listening request in the SIP message, and to send the matching media data to the client terminal.

Since the Session Initiation Protocol has excellent flexibility and functionality, obtaining Internet radio resources based on the Session Initiation Protocol can overcome inconveniences associated with the user's obtaining Internet radio resources on his/her own.

### BRIEF DESCRIPTION OF THE DRAWINGS

Other features and advantages of the present invention will become apparent in the following detailed description of the preferred embodiment with reference to the accompanying drawings, of which:

FIG. 1 is a system block diagram to illustrate a preferred embodiment of a method and system for obtaining Internet radio resources based on Session Initiation Protocol according to the present invention, which is suitable for use among an administrator server, a plurality of radio station terminals, and a plurality of client terminals;

FIG. 2 is a flowchart to illustrate the steps of collecting radio station data by the administrator server in the preferred embodiment;

FIG. 3 is a message flow diagram to illustrate the communication process in which the administrator server collects radio station data;

FIG. 4 is a flow diagram to illustrate the steps performed in the preferred embodiment when a client terminal requests the administrator server to search for radio station data;

FIG. 5 is a message flow diagram to illustrate the communication process when the client terminal requests the administrator server to search for radio station data;

FIG. 6 is a flowchart to illustrate the steps performed in the preferred embodiment when a client terminal requests trial listening radio media data from the administrator server; and

FIG. 7 is a message flowchart to illustrate the communication process when the client terminal requests trial listening radio media data from the administrator server.

### DETAILED DESCRIPTION OF THE PREFERRED EMBODIMENT

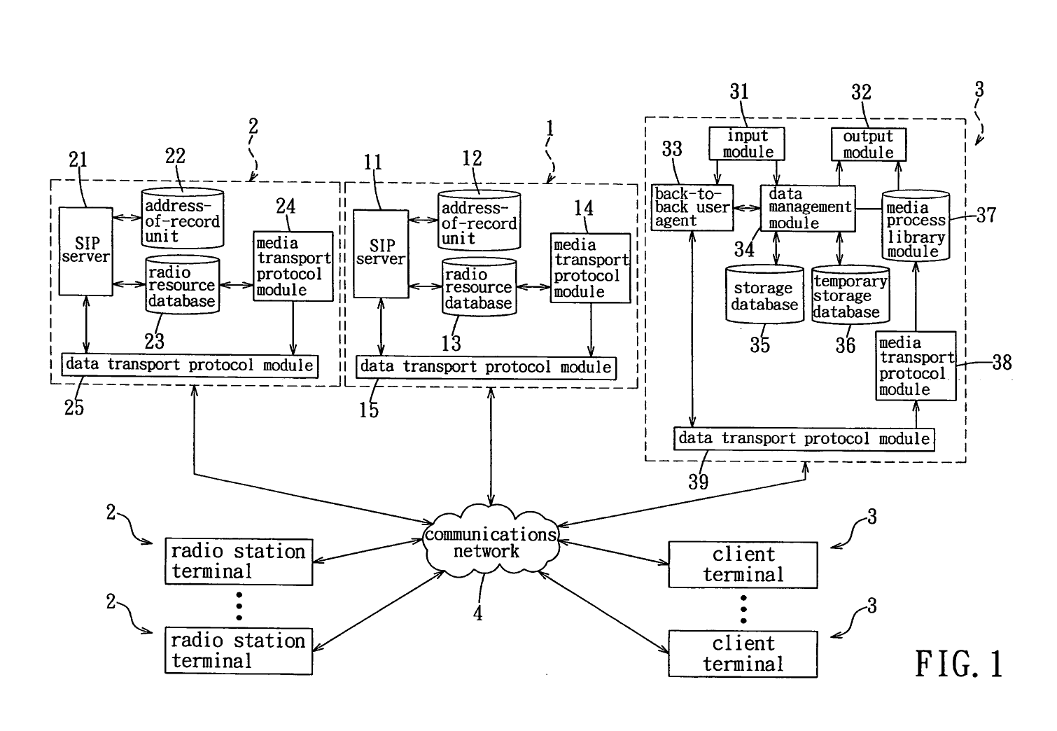

Referring to FIG. 1, the preferred embodiment of a method and system for obtaining Internet radio resources based on Session Initiation Protocol (hereinafter referred to as SIP) according to the present invention is adapted for use in an environment that includes an administrator server 1, a plurality of radio station terminals 2, and a plurality of client terminals 3. The administrator server 1, the radio station terminals 2 and the client terminals 3 are all connected to a communications network 4.

It is first noted herein that the functions of the radio station terminals 2, the administrator server 1, and the client terminals 3 are separate in this preferred embodiment, but functions of the radio station terminals 2, the administrator server 1, and the client terminals 3 may be combined with each other in practical application. As an example, the radio station terminals 2 may also have the function of the administrator server 1 to provide station-related data required by different client terminals 3.

The main concept of the method of this invention is that, after the client terminal 3 has set up a tunnel with the administrator server 1 based on the SIP, the client terminal 3 can send a SIP message requesting radio station data to the administrator server 1 through the tunnel, and the administrator server 1 can then provide the requested radio station data to the client terminal 3 through the tunnel. Hence, since SIP has excellent flexibility and functionality, inconveniences associated with the user's searching on his/her own can be eliminated.

The function of the administrator server 1 is mainly to provide station-related data required by different client terminals 3, and to receive/store radio station data of different radio station terminals 2. The radio station data include introduction data or media data of various radio stations.

The administrator server 1 includes a SIP server 11, an address-of-record unit 12, a radio resource database 13, a media transport protocol module 14, and a data transport protocol module 15.

The SIP server 11 is responsible for packeting and sending SIP request messages, and receiving and extracting response messages. The address-of-record unit 12 is used to record a registration message of the user. The radio resource database 13 stores introduction data and media data of various radio stations. The media transport protocol module 14 is responsible for transmitting media data, e.g., transmitting media data to the client terminal 3. The data transport protocol module 15 is responsible for transmitting/receiving data to/from the communications network 4.

The address-of-record unit 12 records the registration messages of the users of the radio station terminal 2 and the client terminals 3, including account name, password, communication address, expiry time, etc. For instance, the registration message of a radio station terminal 2 includes CCB, 123456, CCB@10.42.10.10, 3600, etc. The registration message of a client terminal 3 includes Bob, 123456, Bob@192.168.10.10, 1800, etc.

The radio resource database 13 has introduction data and trial listening media data of various radio stations. Content of the introduction data of a radio station includes name of the radio station, communication address, minimum bandwidth requirement, supported media type, radio style, country name, language type, whether registration is required, etc., which may be used as keywords for searching. An example of such content is: CCB, www.ccb.com 12 k, JPEG/GIP/iLBC/G.711/G.729/MP3/MPEG-4, NEWS, UK, English/Chinese/French, No registration required. The media data may be an image, an audio, a video or an audiovisual file.

Each radio station terminal 2 is similar to the administrator server 1 in architecture, and includes a SIP server 21, an address-of-record unit 22, a radio resource database 23, a media transport protocol module 24, and a data transport protocol module 25. For the components mentioned herein, reference can be made to the introduction of the corresponding components of the administrator server 1.

Each client terminal 3 is to be operated by the user to obtain radio resources from the administrator server 1 or the radio station terminal 2 through the communications network 4. The client terminal 3 may be, e.g., a Voice over Internet Protocol (VoIP) phone or other SIP-based electronic communication products.

Each client terminal 3 includes an input module 31, an output module 32, a back-to-back user agent 33, a data management module 34, a storage database 35, a temporary storage database 36, a media process library (MPL) module 37, a media transport protocol module 38, and a data transport protocol module 39.

The data management module 34 is used to manage radio-related introduction data in the storage database 35 and the temporary storage database 36. The storage database 35 is managed by storing in the storage database 35 the introduction data of designated radio station terminals 2 according to the user's requirement, which is similar to the function of “My Favorites.” The temporary storage database 36 is for temporary storage of currently received radio station data.

The input module 31 is operable by the user to generate control commands, such as search, trial listening, etc. The back-to-back user agent 33 is responsible for packeting a control command from the input module 31 into a SIP request message, and to receive and extract a SIP response message.

The data transport protocol module 39 is responsible for outputting data to the communications network 4 and for receiving data from the communications network 4. The media transport protocol module 38 is responsible for transmitting a portion of media data to the media process library module 37. The media process library module 37 is used to process the media data into data suitable for outputting. The output module 32 is used to output processing results from the data management module 34 and the media process library module 37, which include text, images, audio, video, audiovisual data, etc.

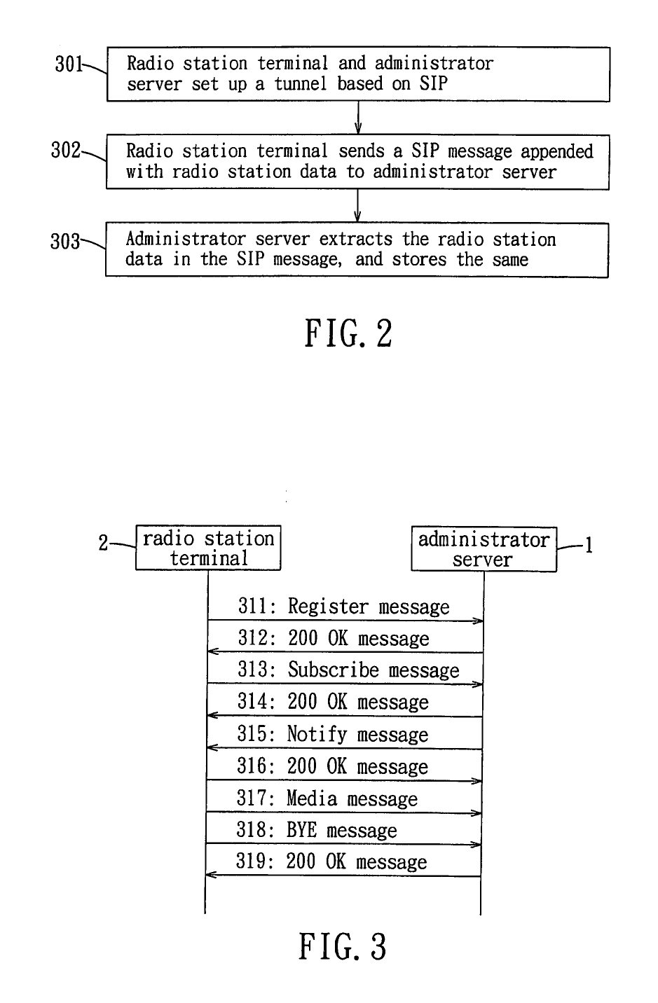

Referring to FIGS. 1 and 2, in the method for obtaining Internet radio resources based on the SIP according to the present invention, the process in which the administrator server 1 collects radio station data of each radio station terminal 2 includes the following steps.

The radio station terminal 2 and the administrator server 1 set up a tunnel based on the SIP (step 301). The radio station terminal 2 sends a SIP message appended with radio station data to the administrator server 1 (step 302). The radio station data may include introduction data and media data. Thereafter, the administrator server 1 extracts the radio station data in the SIP message, and stores the radio station data in the radio resource database 13 (step 303).

Referring to FIG. 3, during the communication process of collecting radio station data by the administrator server 1, the administrator server 1 first receives a register message sent from the radio station terminal 2 (step 311). The register message is appended with the account name, password, and link address of the radio station terminal 2, expiry time to determine when to disconnect, etc., so as to notify the administrator server 1 how to transmit future news data. Upon receipt thereof, the administrator server 1 sends back a 200 OK message to indicate that setup of a SIP-compliant tunnel has been completed (step 312).

Subsequently, the radio station terminal 2 sends a subscribe message appended with introduction data to the administrator server 1 (step 313). Upon receipt, the administrator server 1 will send back a 200 OK message (step 314) to indicate receipt of the introduction data. Thereafter, the administrator server 1 extracts the introduction data in the subscribe message, stores the introduction data in the radio resource database 13, and further sends a notify message to the radio station terminal 2 to notify the radio station terminal 2 of successful storage (step 315). The radio station terminal 2 then responds with a 200 OK message (step 316).

Subsequently, the radio station terminal 2 starts to transmit media data for trial listening to the administrator server 1 (step 317), and the administrator server 1 stores the media data. In the event of successful transmission of the media data, the radio station terminal 2 sends a BYE message to terminate the connection (step 318). Upon receipt thereof, the administrator server 1 will send back a 200 OK message (step 319), thereby ending the entire process.

It is noted herein that, in addition to the radio station terminal 2 which actively provides data, the administrator server 1 may also be configured to automatically search and set up radio station data, which should be deemed to fall within the scope of the present invention regardless of what means are adopted, so long as radio station data can be acquired and set up based on the SIP.

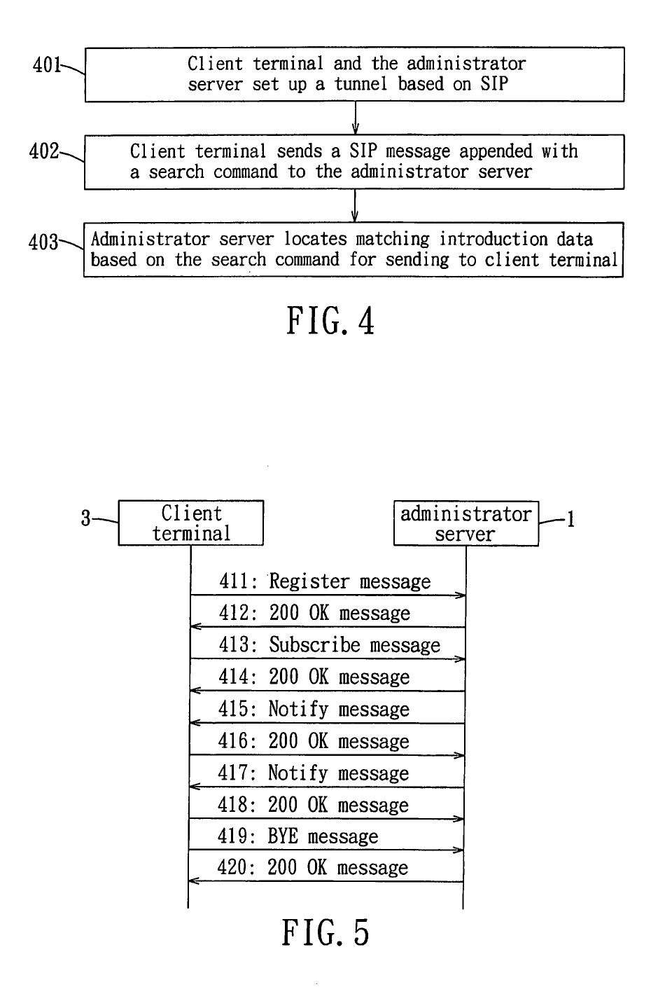

Referring to FIGS. 1 and 4, when the client terminal 3 requests the administrator server 1 to search for radio station data, the process includes the following steps:

The client terminal 3 and the administrator server 1 set up a tunnel based on the SIP (step 401). The client terminal 3 sends a SIP message appended with a search command to the administrator server 1 through the tunnel (step 402). The administrator server 1 locates matching introduction data in the radio resource database 13 based on the search command in the SIP message, and then sends a notify message including the introduction data to the client terminal 3 (step 403).

Referring to FIG. 5, the client terminal 3 requests the administrator server 1 to search for introduction data of a radio station related to a keyword. First, the client terminal 3 sends a register message (step 411). The register message is appended with the account name, password, and link address of the client terminal 3, expiry time to determine when to disconnect, etc., so as to notify the administrator server 1 how to transmit future news. Upon receipt thereof, the administrator server 1 sends back a 200 OK message to indicate that setup of the SIP-compliant tunnel has been completed (step 412).

Thereafter, the client terminal 3 sends a subscribe message including a keyword search command to the administrator server 1 (step 413). Upon receipt thereof, the administrator server 1 will send back a 200 OK message (step 414) to indicate receipt of the subscribe message. Subsequently, after conducting a comparison through the radio resource database 13 based on the keyword, supposing two entries of matching introduction data are located, the administrator server 1 sends a notify message to the client terminal 3 (step 415). The notify message includes the first entry of introduction data located based on the keyword. The client terminal 3 stores the first entry of introduction data in the temporary storage database 36 after receipt thereof, and responds with a 200 OK message (step 416). Then, the administrator server 1 sends another notify message to notify the client terminal 3 of the located second entry of matching introduction data (step 417). The client terminal 3 stores the second entry of introduction data in the temporary storage database 36 after receipt thereof, and responds with a 200 OK message (step 418). If there are a larger number of entries of introduction data, they can be stored in the temporary storage database 36 one by one in the manner as described hereinabove.

If the client terminal 3 wishes to end the transmission of data, the client 3 sends a BYE message to terminate the connection (step 419). Upon receipt thereof, the administrator server 1 will send back a 200 OK message (step 420), thereby ending the entire process.

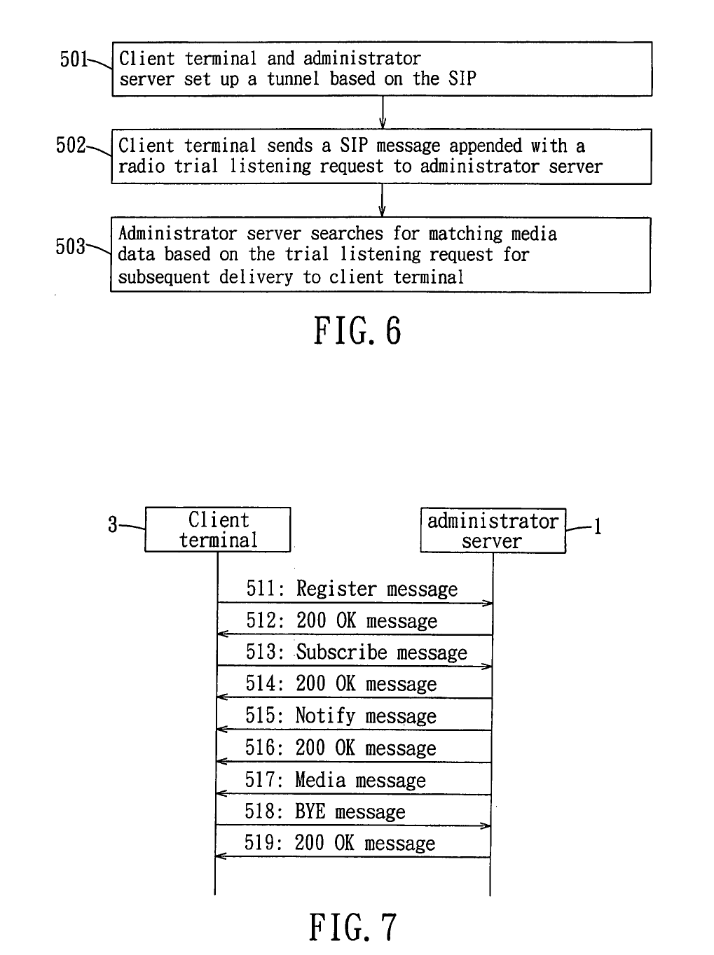

Referring to FIGS. 1 and 6, in addition to searching for introduction data of radio stations, the client terminal 3 can also request trial listening media data of radio stations from the administrator server 1 through SIP. The process includes the following steps:

The client terminal 3 and the administrator server 1 set up a tunnel based on the SIP (step 501). The client terminal 3 sends a SIP message appended with a radio trial listening request to the administrator server 1 through the tunnel (step 502). The administrator server 1 searches the radio resource database 13 for matching media data based on the trial listening request in the SIP message for subsequent delivery to the client terminal 3 (step 503).

FIG. 7 illustrates the communication process in which the client terminal 3 requests trial listening radio media data from the administrator server 1. First, the client terminal 3 sends a register message (step 511). Upon receipt thereof, the administrator server 1 sends back a 200 ACK message (step 512) to indicate that setup of a SIP-compliant tunnel has been completed.

Subsequently, the client terminal 3 sends a subscribe message including a trial listening request with the name of a radio station to the administrator server 1 (step 513). Upon receipt thereof, the administrator server 1 sends back a 200 OK message to indicate receipt of the trial listening request (step 514). Then, the administrator server 1 conducts a comparison through the radio resource database 13 based on the name of the radio station in the trial listening request, and sends a notify message to the client terminal 3 if trial listening media data of the radio station are located (step 515). Upon receipt thereof, the client terminal 3 responds with a 200 OK message (step 516). Thereafter, the administrator server 1 starts transmitting the media data that were located according to the name of the radio station to the client terminal 3 (step 517). The client terminal 3 sends a BYE message to terminate the connection if the trial listening is to be ended (step 518). After receipt thereof, the administrator server 1 will send back a 200 OK message (step 519) thereby ending the entire process.

In sum, the method and system for obtaining Internet radio resources based on the SIP according to the present invention have the following characteristics:

1. SIP has excellent openness, and is applicable to any terminal to share radio resources using a communications network as platform.

2. SIP has excellent flexibility, and is applicable to local area networks at homes, businesses, etc., and to the Internet.

3. The invention is applicable to network phones having SIP functionality to permit diversification of functions of network phones.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method for obtaining Internet radio resources based on Session Initiation Protocol, the method being adapted for use between an administrator server and at least one client terminal, and comprising the following steps:
(a) enabling the client terminal and the administrator server to set up a tunnel based on Session Initiation Protocol (SIP);
(b) enabling the client terminal to send a SIP message requesting radio station data to the administrator server through the tunnel; and
(c) enabling the administrator server to provide requested radio station data to the client terminal through the tunnel.

2. The method for obtaining Internet radio resources based on Session Initiation Protocol according to claim 1, wherein the radio station data stored in the administrator server include at least one of introduction data and media data of various radio stations.

3. A method for obtaining Internet radio resources based on Session Initiation Protocol, the method being adapted for use between an administrator server and at least one radio station terminal, and comprising the following steps:
(a) enabling the radio station terminal and the administrator server to set up a tunnel based on Session Initiation Protocol (SIP);
(b) enabling the radio station terminal to send a SIP message appended with radio station data to the administrator server through the tunnel; and
(c) enabling the administrator server to obtain the SIP message through the tunnel and to store the radio station data therein in a radio resource database.

4. The method for obtaining Internet radio resources based on Session Initiation Protocol according to claim 3, wherein step (a) includes the following sub-steps:
(a1) enabling the radio station terminal to send a register message to the administrator server; and
(a2) enabling the administrator server to send back a 200 OK message to the radio station terminal to indicate completion of setup of the Session Initiation Protocol-based tunnel after receipt of the register message.

5. The method for obtaining Internet radio resources based on Session Initiation Protocol according to claim 4, wherein the register message includes an account name, a password, and a communication address of the radio station terminal.

6. The method for obtaining Internet radio resources based on Session Initiation Protocol according to claim 3, wherein the radio station data are introduction data of the radio station terminal, the method further comprising the following steps after step (c):
(d) enabling the radio station terminal to transmit media data to the administrator server through the tunnel; and
(e) enabling the administrator server to store the media data in the radio resource database.

7. A system for obtaining Internet radio resources based on Session Initiation Protocol (SIP), comprising:
at least one radio station terminal, which sends a SIP message appended with radio station data through a tunnel compliant with the Session Initiation Protocol; and
an administrator server connected to said radio station terminal through a communications network including a radio resource database, and disposed to extract the radio station data from the SIP message for storage in said radio resource database thereof.

8. The system for obtaining Internet radio resources based on Session Initiation Protocol according to claim 7, wherein the radio station data are introduction data with content including one of a name of a radio station, a communication address, a minimum bandwidth requirement, a supported media type, a radio style, a country name, a language type, and whether registration is required.

9. The system for obtaining Internet radio resources based on Session Initiation Protocol according to claim 7, wherein said administrator server further includes:
an address-of-record unit for recording a register message having a communication address sent by said radio station terminal; and
a SIP server module responsible for sending back to said radio station terminal a 200 OK message indicating completion of setup of the Session Initiation Protocol-compliant tunnel upon receipt of the register message.

10. The system for obtaining Internet radio resources based on Session Initiation Protocol according to claim 9, wherein the register message includes an account name, a password, and a communication address of said radio station terminal.

11. The system for obtaining Internet radio resources based on Session Initiation Protocol according to claim 7, wherein said administrator server further includes:
a media transport protocol module for receiving media data from said radio station terminal and for storing the media data in said radio resource database.

12. A system for obtaining Internet radio resources based on Session Initiation Protocol (SIP), comprising:
a client terminal, which sends a SIP message appended with a search command to search for a radio station terminal through a tunnel compliant with the Session Initiation Protocol; and
an administrator server connected to said client terminal through a communications network and including a radio resource database, said administrator server receiving the SIP message through the tunnel, locating matching radio station data from said radio resource database based on the search command in the SIP message, and subsequently sending another SIP message having the matching radio station data to the client terminal.

13. The system for obtaining Internet radio resources based on Session Initiation Protocol according to claim 12, wherein the radio station data are introduction data with content including one of a name of a radio station, a communication address, a minimum bandwidth requirement, a supported media type, a radio style, a country name, a language type, and whether registration is required.

14. The system for obtaining Internet radio resources based on Session Initiation Protocol according to claim 12, wherein said administrator server further includes:
an address-of-record unit for recording a register message having a communication address sent by said client terminal; and
a SIP server module responsible for sending back to said client terminal a 200 OK message to indicate completion of the tunnel compliant with the Session Initiation Protocol upon receipt of the register message.

15. The system for obtaining Internet radio resources based on Session Initiation Protocol according to claim 14, wherein the register message includes an account name, a password, and a communication address of said client terminal.

16. The system for obtaining Internet radio resources based on Session Initiation Protocol according to claim 12, wherein said client terminal includes:
an input module operable by the user to generate the search command to search for a radio station terminal;
a data transport protocol module responsible for transmitting and receiving data to and from the communications network;
aback-to-back user agent responsible for packeting the search command from said input module into the SIP message and for extracting the SIP message from said data transport protocol module; and
a temporary storage database for temporary storage of data received by said data transport protocol module.

17. The system for obtaining Internet radio resources based on Session Initiation Protocol according to claim 12, wherein said client terminal includes:
a data management module that manages the radio station data of radio station terminals according to user requirement; and
a storage database for storing the radio station data of the radio station terminals which are specified by said data management module.

18. A system for obtaining Internet radio resources based on Session Initiation Protocol (SIP), comprising:
at least one client terminal, which sends a SIP message appended with a trial listening request in respect of a radio station terminal through a tunnel compliant with the Session Initiation Protocol; and
an administrator server connected to said client terminal through a communications network and including a radio resource database, said administrator server receiving the SIP message through the tunnel, locating matching media data from said radio resource database based on the trial listening request in the SIP message, and sending the matching media data to said client terminal.

19. The system for obtaining Internet radio resources based on Session Initiation Protocol according to claim 18, wherein said administrator server further includes a media transport protocol module for transmitting the matching media data to said client terminal, the matching media data being one of an image, an audio, a video, and an audiovisual file.

20. The system for obtaining Internet radio resources based on Session Initiation Protocol according to claim 18, wherein said administrator server further includes:
an address-of-record unit for recording a register message sent by said client terminal; and
a SIP server module responsible for sending back to said client terminal a 200 OK message to indicate completion of setup of the tunnel compliant with the Session Initiation Protocol upon receipt of the register message.

21. The system for obtaining Internet radio resources based on Session Initiation Protocol according to claim 20, wherein said register message includes an account name, a password, and a communication address of said client terminal.

22. The system for obtaining Internet radio resources based on Session Initiation Protocol according to claim 18, wherein said client terminal includes:
an input module operable by the user to generate the trial listening request to search for the radio station terminal;
a data transport protocol module responsible for transmitting and receiving data from the communications network;
aback-to-back user agent responsible for packeting the trial listening request from said input module into the SIP message and for extracting the SIP message from said data transport module; and
a temporary storage database for temporary storage of data received by said data transport protocol module.

23. The system for obtaining Internet radio resources based on Session Initiation Protocol according to claim 18, wherein said client terminal includes:
a media process library module for processing the matching media data; and
an output module for outputting results of processing of the matching media data by said media process library module.
